(19) United States
(12) Patent Application Publication
(10) Pub. No.: US 2025/0353155 A1
(43) Pub. Date: Nov. 20, 2025

(54) HAND TOOL INTEGRATING A RETRACTABLE KNIFE

(71) Applicant: Corey Brackin, Centerton, AR (US)

(72) Inventor: Corey Brackin, Centerton, AR (US)

(21) Appl. No.: 19/208,496

(22) Filed: May 14, 2025

Related U.S. Application Data
(60) Provisional application No. 63/647,220, filed on May 14, 2024.

(51) Int. Cl. B25F 1/04; B29C 63/02

(52) U.S. Cl. CPC B25F 1/04; B29C 63/02; B29C 2063/027

(57) ABSTRACT

A hand tool integrating a retractable knife is disclosed. The hand tool includes a squeegee having a cut-section to accommodate a separate and removable retractable knife. The retractable knife is operated to both smooth a material such as vinyl and make accurate cuts on the material as needed. When cutting is not needed, the retractable knife is removed from the squeegee, allowing for standard squeegee usage when smoothing tasks are required. The hand tool integrates a retractable knife into the squeegee, allowing a user to seamlessly transition between smoothing and cutting tasks without the need for separate devices. The hand tool can be used for efficient and precise installation of vehicle wraps, for example.

### CROSS REFERENCE TO RELATED APPLICATIONS

The present application claims benefit of Provisional Application No. 63/647,220, filed May 14, 2024; all which are incorporated herein in their entirety and referenced thereto.

### BACKGROUND OF THE INVENTION

### Field of the Invention

The present invention relates to hand tools, and in particular, relates to a hand tool integrating a retractable knife enabling users to achieve heightened accuracy and efficiency during cutting and smoothing tasks in material installation.

### Description of the Prior Art

It is known that vehicle wraps are a popular way to customize the appearance of automobiles, motorcycles, and other vehicles. The vehicle wraps involve adhering vinyl sheets to the exterior surface of a vehicle. The vehicle wrap is typically installed by carefully measuring, cutting and applying the vinyl sheet to the contours of the vehicle. Generally, a squeegee is used for installation of the vehicle wrap. The squeegee is used to smooth and adhere the vinyl sheet to the exterior surface of the vehicle without leaving any air bubbles. During the installation, a user or installer makes precise cuts to the vinyl sheet to accommodate a specific contour, say a side mirror of the vehicle. In order to cut the vinyl sheet, typically the user uses a separate knife which is cumbersome and increases the risk of accidental cuts to the vinyl sheet or damage to the vehicle.

Several attempts have been made to overcome the above problems by integrating a cutting blade directly into the squeegee. One such example is disclosed in a United States Publication No. 20230104575, entitled “Hand tool with cutting device” (“the '575 Publication”). The '575 Publication discloses a hand tool having a squeegee and a retractable blade. The hand tool includes a main case having at least one flat edge. A squeegee is positioned on the flat edge of the main case and a retractable blade is extendable from the main case. The squeegee and retractable blade are incorporated in the single hand tool for use when desired by the user.

Another example is disclosed in a United States Publication No. 20080307599, entitled “Multi-purpose squeegee and cutting tool” (“the '599 Publication”). The '599 Publication discloses a multi-purpose squeegee and cutting tool for use by the human hand. The tool meets the continuing need to be able to apply adhesive films to smooth surfaces without capturing air bubbles, creases in the film or adhesive lumps between the film and the surface. The disclosed invention is a new and novel multi-purpose tool that can be used to remove creases in the film, bubbles and lumps while having a built-in knife for piercing bubbles, cutting and trimming the adhesive film.

Another example is disclosed in a U.S. Pat. No. 8,215,364, entitled “Ergonomic squeegee with blade for adhesions and detachment” (“the '364 Patent”). The '364 Patent discloses an improved squeegee and method of modifying a conventional squeegee. A novel hand tool for adherence assistance and cutting of tapes with threads incorporated into it. The squeegee is approximately 4 inches by 3 inches and held in one hand. While rubbing over the surface of the tape being adhered with the 4-inch elongated side causing friction heat for the glue of the tape to adhere. Turning the squeegee around to the other elongated 4-inch side where there is a cutting blade to separate the tape from the roll. The squeegee will provide a simplified and more commercially feasible method for a hand-held tool for adherence and separation of tapes.

Although the above discussed disclosures are useful, they have few problems. For example, the cutting device integrated into the squeegee can be inconvenient, as the cutting device is fixed in place (built-in) and cannot be removed or replaced. An exposed cutting device presents a potential hazard to the user during or after its use.

Therefore, there is a need in the art to provide an improved hand tool integrating a retractable knife, in which the retractable knife can be incorporated as a separate, removable cutting tool allowing the retractable knife to be removed for normal squeegee use.

### SUMMARY OF THE INVENTION

It is an object of the present invention to provide a squeegee that can selectively incorporate a separate, removable retractable knife and that overcomes the drawback of known squeegees integrating the cutting tools.

It is another object of the present invention to provide a uniquely designed squeegee for removably receiving a retractable knife, allowing seamless transitioning between smoothing and cutting tasks without the need for separate devices.

In order to achieve one or more objects, the present subject matter provides a hand tool integrating a retractable knife. The hand tool includes a squeegee having a cut-section. The cut-section extends at an angle from the substantially center at one side until it reaches the other side of the squeegee, at a top surface of the squeegee. The cut-section removably receives the retractable knife. The retractable knife includes a blade. The blade is slidably operated to extend and retract into a body of the retractable knife.

When needed, the retractable knife is placed in the squeegee, allowing a user to use the squeegee as a guide in cutting material with better accuracy. When cutting is not needed, the user removes the retractable knife from the squeegee, allowing the squeegee to be used as normal.

In one advantageous feature of the present subject matter, the hand tool combines cutting and smoothing functions into a single tool thereby reducing the need for multiple devices.

In another advantageous feature of the present subject matter, the hand tool with integrated retractable knife allows the user to use the squeegee as a guide for precise material cutting, resulting in cleaner edges and intricate cuts.

In another advantageous feature of the present subject matter, the retractable knife is very easy to remove from the squeegee, allowing for standard squeegee usage when smoothing tasks are required.

In yet another advantageous feature of the present subject matter, the uniquely designed squeegee integrating the retractable knife can be used for installation of materials like vinyl, wallpaper, or adhesive film on a variety of objects. Specifically, the squeegee can be used for vehicle wrap applications with cleaner edges and intricate cuts.

In yet another advantageous feature of the present subject matter, the retractable knife reduces the risk of injuries associated with traditional cutting devices during or after its use.

These and other objects of the present invention will be apparent from review of the following specification and the accompanying drawings.

### BRIEF DESCRIPTION OF THE DRAWINGS

FIG. 1 is an environment in which a hand tool implements, in accordance with one exemplary embodiment of the present subject matter.

FIG. 2A and FIG. 2B illustrate a side perspective view and a front view, respectively of the hand tool, in accordance with one embodiment of the present subject matter.

FIG. 3A, FIG. 3B, FIG. 3C and FIG. 3D illustrate a front view, a perspective view, a side view and a bottom view, respectively of a squeegee, in accordance with one embodiment of the present subject matter.

FIG. 4A and FIG. 4B illustrate a top view and a bottom view, respectively of a retractable knife, in accordance with one embodiment of the present subject matter;

FIG. 5 illustrates the hand tool in which is a blade is retracted, in accordance with one embodiment of the present subject matter; and

FIG. 6 illustrates the hand tool in which is the blade is protruding out for cutting operation, in accordance with one embodiment of the present subject matter.

### DETAILED DESCRIPTION OF THE PREFERRED EMBODIMENT

The detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed hand tool. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed hand tool.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter describes a hand tool, it is to be further understood that numerous changes may arise in the details of the embodiments of the hand tool. It is contemplated that all such changes and additional embodiments are within the spirit and true scope of this subject matter.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the subject matter and are not intended to limit the scope of the subject matter.

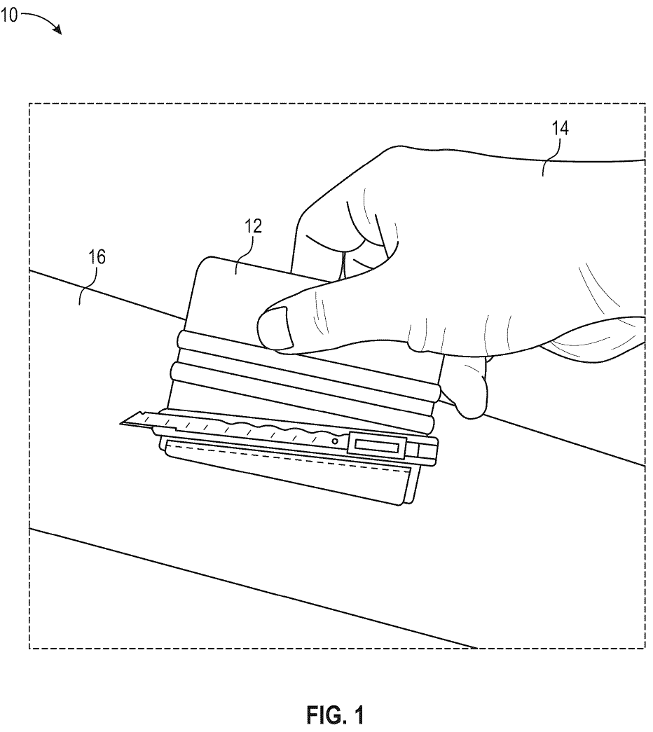

Various features and embodiments of a hand tool are explained in conjunction with the description of FIGUREs (FIGS. 1-6.

FIG. 1 shows an environment 10 in which a hand tool 12 implements, in accordance with one embodiment of the present subject matter. Hand tool 12 indicates a handheld tape application and cutting tool, a squeegee cum cutting blade, or a squeegee integrating knife. A user 14 holds hand tool 12 to adjust and cut a material 16. The present subject matter is explained in the context of applying material such as a vehicle wrap/vinyl sheet on a vehicle (not shown) to customize its appearance. However, hand tool 12 can also be used in other applications, such as in the installation of materials like vinyl, adhesive film, wallpaper, or other materials on a variety of objects without departing from the scope of the present subject matter.

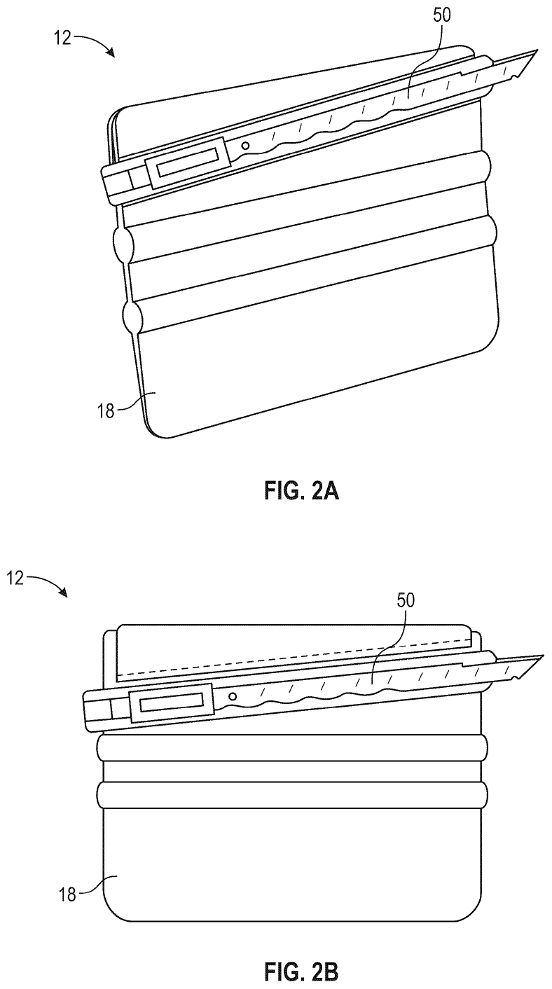

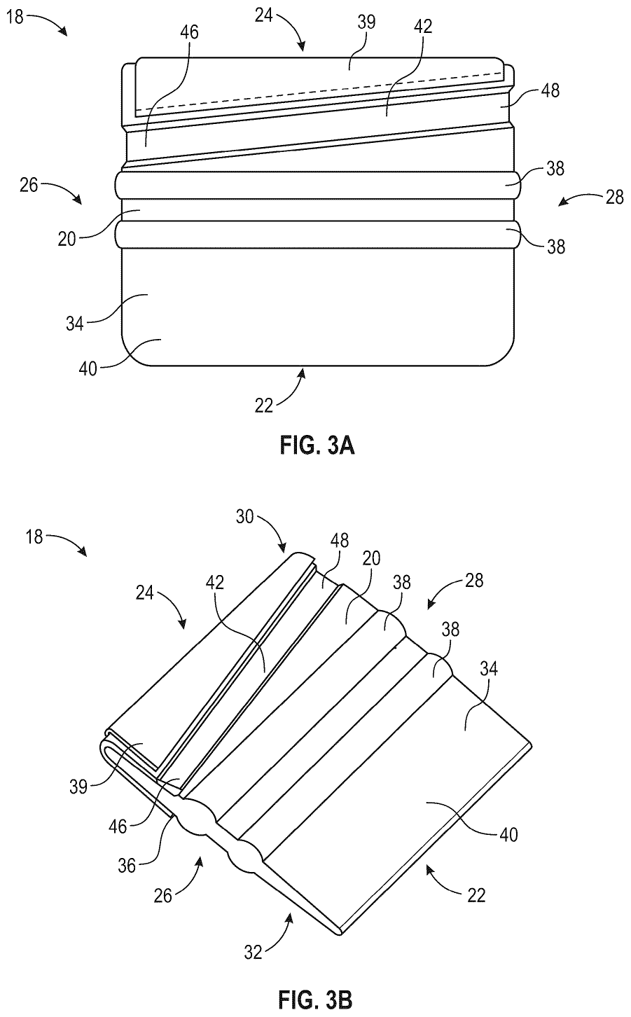

FIG. 2A and FIG. 2B show a front view and a side perspective view, respectively of hand tool 12, in accordance with one embodiment of the present subject matter. As can be seen, hand tool 12 includes a squeegee 18 and a retractable knife 50. FIG. 3A, FIG. 3B, FIG. 3C and FIG. 3D show a front view, a perspective view, a side view and a bottom view, respectively of squeegee 18, in accordance with one embodiment of the present subject matter. Squeegee 18 includes a body 20 made of plastic, polypropylene, rubber, leather, impregnated or laminated fibrous materials, cardboard, paper, or any other suitable material. Body 20 has a suitable strength and flexibility for use in the various applications as known in the art. Body 20 has a front end 22, a rear end 24, a first side 26, a second side 28, a top end 30, and a bottom end 32. Front end 22 indicates a front portion of body 20 and rear end 24 indicates a rear portion of body 20, or vice versa. First side 26 indicates a right side of body 20, and second side 28 indicates a left side of body 20, or vice versa. The surface of body 20 facing top end 30 is referred as a top surface 34, and the surface of body 20 facing bottom end 32 is referred as a bottom surface 36. Top surface 34 and bottom surface 36 of body 30 are indicated in at least FIG. 3B and FIG. 3C.

Further, body 20 encompasses ridges 38. Ridges 38 position at the substantially center of body 20 and run parallel to each other at both top surface 34 and bottom surface 36 of body 20. As can be seen from FIG. 3A, FIG. 3B and FIG. 3C, ridges 38 extend along the entire length of body 20 horizontally from first side 26 to second side 28. Ridges 38 help user 14 to hold squeegee 18 firmly during its use. In one example, body 20 has a tapered section 40 at distal ends i.e., towards front end 22 and rear end 24. Optionally, body 20 has tapered section 40 only at front end 22. Tapered section 40 at front end 22, or both front end 22 and rear end 24 forms a felt edge to help prevent scratching or hurt when applying material 16 on the surface of the object (not shown, for example the surface of a vehicle).

In one example, body 20 encompasses a fabric member 39 at rear end 24. As can be seen from at least FIG. 3B, fabric member 39 positions at top surface 34, goes around rear end 24 and extends until substantially center of bottom surface 36. FIG. 3D shows a bottom view of squeegee 18 having fabric member 39 at bottom surface 36. In one example, fabric member 39 is made of a breathable and durable material to protect material or vinyl 18 from scratches. Optionally, fabric member 39 can be used as a material scrapper or vinyl scrapper during the uninstallation of material 16.

In accordance with the present subject matter, body 20 presents a cut-section or a knife receiving area 42 at top surface 34. Cut-section 42 extends from first side 26 to second side 28 at an angle, say 10-45 degrees, as can be seen in at least FIG. 3A and FIG. 3B. A person skilled in the art understands that the angle at which cut-section 42 is provided can vary depending on the need. As can be seen from at least FIG. 3A and FIG. 3B, cut-section 42 starts at the substantially center at first side 26 and extends at an angle until it reaches the second side 28. Optionally, cut-section 42 can start at the substantially center at second side 28 and extend at an angle until it reaches first side 26. Here, cut-section 42 can be provided to suit either right hand or left-hand (or both) cutting ability for user 14.

In one example, cut-section 42 presents a slant section 44. Slant section 44 helps to position retractable knife 50 at an angle such that it becomes easy to cut material 16 with retractable knife 50 while moving hand tool 12 over material 16. Cut-section 42 presents a first end 46 and a second end 48. First end 46 is proximity to first side 26 and second end 48 is proximity to second side 28.

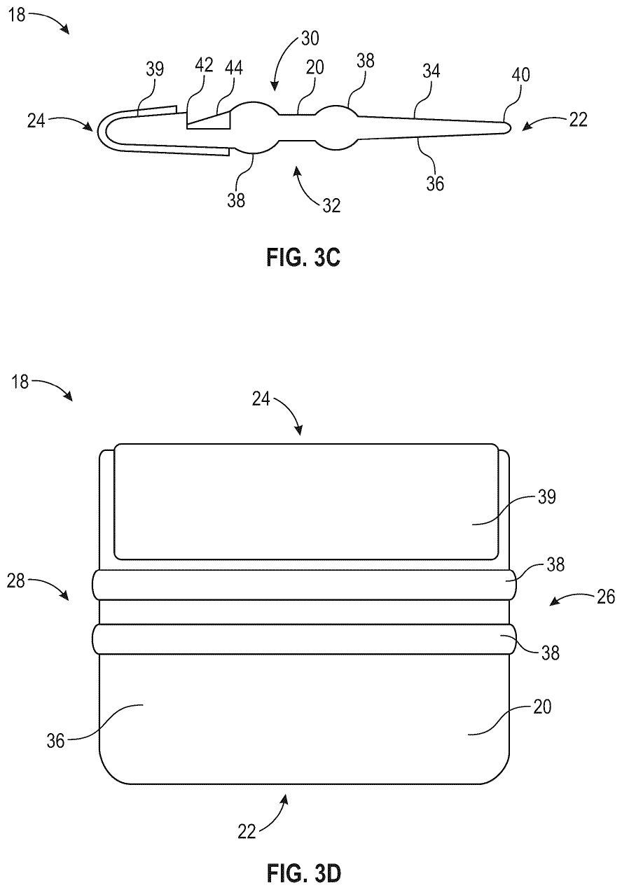

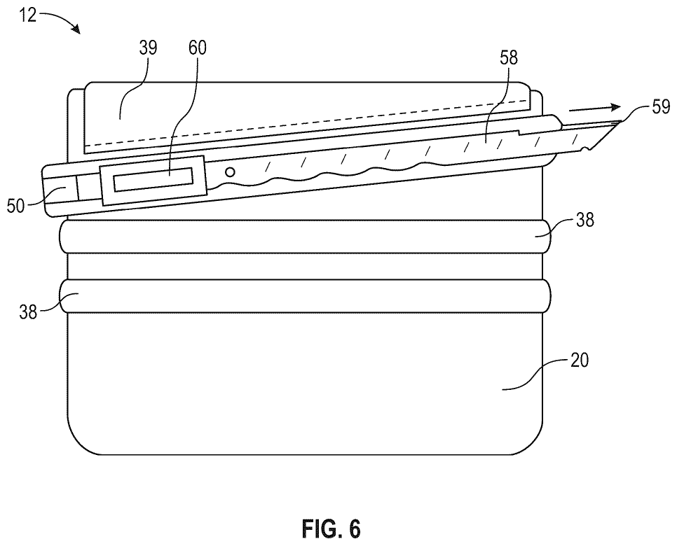

As presented above, hand tool 12 includes squeegee 18 and retractable knife 50. Referring to FIG. 4A and FIG. 4B, a top view and a bottom view, respectively of retractable knife 50 is shown, in accordance with one embodiment of the present subject matter. Retractable knife 50 indicates a cutting tool such as a utility knife e.g., X-ACTO™ knife used for cutting material 16. Retractable knife 50 presents a knife body 52 having a blade receiving area or blade slot 54. Blade receiving area 54 extends substantially the length of knife body 52 and includes curved edges 56. Blade receiving area 54 receives a blade 58. Blade 58 encompasses a blade tip 59 which is angled, say at 30 degrees, for example. Blade 58 encompasses a slider 60. Slider 60 connects at one end of blade 58 and allows to move blade 58 along blade receiving area 54 such that blade 58 extends and retracts into blade receiving area 54. Extending blade 58 exposes blade tip 59, as can be seen from FIG. 6, for example. In one embodiment, knife body 52 includes a connecting member 62. Connecting member 62 indicates a clip or U-shaped member that clips onto body 20 while retractable knife 50 is positioned in cut-section 42. In other words, connecting member 62 helps to removably connect retractable knife 50 to squeegee 18 at cut-section 42.

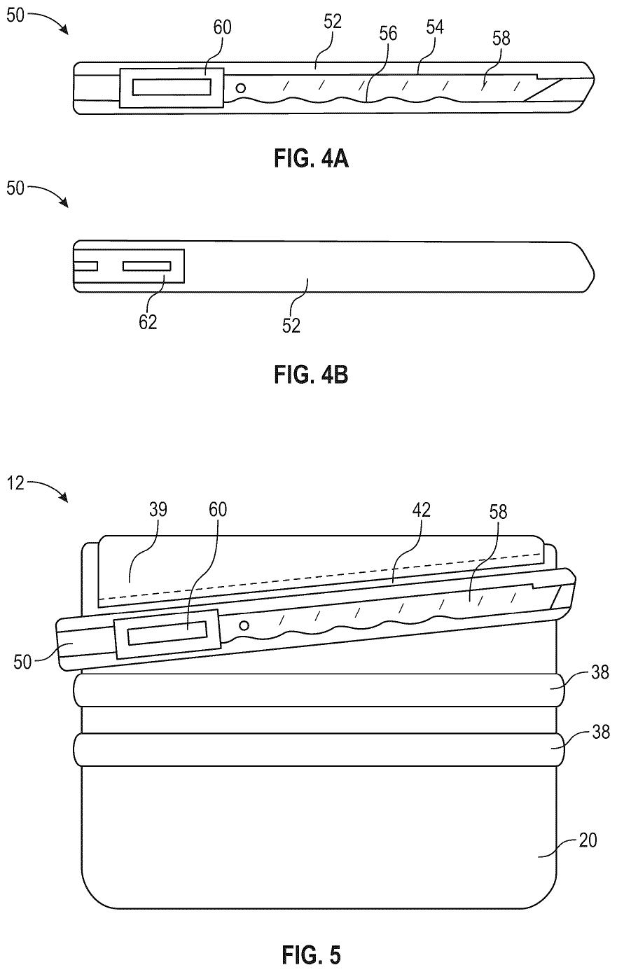

Now referring to FIG. 5 and FIG. 6, the operation of hand tool 12 is explained, in accordance with one embodiment of the present subject matter. In a first configuration, hand tool 12 is used as squeegee 18 integrating retractable knife 50. In a second configuration, hand tool 12 is used only with squeegee 18 as a normal squeegee 18 without retractable knife 50. FIG. 5 and FIG. 6 present the first configuration in which retractable knife 50 is removably connected to squeegee 18. In order to connect retractable knife 50 to squeegee 18, the bottom of retractable knife 50 is aligned with cut-section 42. Here, connecting member 62 is removably connected from first side 26/first end 44 such that knife body 52 sits within cut-section 42 while positioning blade tip 59 at second side 28/second end 46. FIG. 5 shows blade 58 in a retracted configuration. Here, blade 58 stays within blade receiving area 54. When needed, user 14 operates slider 60 to push blade 58 such that blade 58 (along with blade tip 59) extends from knife body 52 exposing blade 58, as shown in FIG. 6. In this extended configuration, user 14 aligns with material 16 to cut it to required measurement.

When cutting of material 16 is not required, user 14 removes retractable knife 50 from squeegee 18 and uses squeegee 18 as a traditional squeegee 18. When compared with the prior art squeegees with integrated cutting tool, presently disclosed hand tool 12 allows user 14 to use hand tool 12 as a guide for making precise cuts to material 16, while also providing the flexibility to remove retractable knife 50 when not needed for normal squeegee use.

The presently disclosed hand tool provides several advantages over the prior art. The hand tool offers a uniquely designed cut-section in the body of the squeegee without affecting the operation of the squeegee with or without the retractable knife. When the retractable knife is needed for cutting operation, the retractable knife is removably positioned in the cut-section for cutting the vinyl material. When not needed, the retractable knife can be removed for using the squeegee normally. The modified squeegee design combines two essential tools into one integrated tool. The hand tool minimizes downtime associated with tool-switching, allowing the user to complete vehicle wrap installation tasks more efficiently.

A person skilled in the art appreciates that the hand tool can come in a variety of shapes and sizes depending on the need and comfort of the user. Further, many changes in the design and placement of components may take place without deviating from the scope of the presently disclosed hand tool.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the subject matter, it is intended that all matter contained in the above description or shown in the accompanying drawings shall be interpreted as illustrative and not in a limiting sense.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. It is contemplated that additional embodiments are within the spirit and true scope of the disclosed subject matter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

I claim:

1. I claim all of the above subject matter.
